(19) United States
(12) Patent Application Publication
(10) Pub. No.: US 2016/0008847 A1
(43) Pub. Date: Jan. 14, 2016

(54) STAMPER UNIT AND METHOD OF MANUFACTURING ELECTROPHORETIC DISPLAY USING THE SAME

(71) Applicant: SAMSUNG ELECTRO-MECHANICS CO., LTD., Suwon-si (KR)

(72) Inventors: Dong Joo SHIN, Suwon-si (KR); Hyun Ho LIM, Suwon-si (KR); Byeong Sung MIN, Suwon-si (KR); Jung Min KIM, Suwon-si (KR)

(73) Assignee: SAMSUNG ELECTRO-MECHANICS CO., LTD., Suwon-si (KR)

(21) Appl. No.: 14/670,931

(22) Filed: Mar. 27, 2015

(30) Foreign Application Priority Data
Jul. 11, 2014 (KR) 10-2014-0087628

(51) Int. Cl. B05D 3/00

(52) U.S. Cl. CPC B05D 3/002; B05D 2350/30

(57) ABSTRACT

There are provided a stamper unit and a method of manufacturing an electrophoretic display by using the stamper unit. The stamper unit includes a stamper on which imprint protrusions are formed and a molding cup that is separably coupled to the stamper and covers the imprint protrusions.

### CROSS-REFERENCE TO RELATED APPLICATION

This application claims the benefit of Korean Patent Application No. 10-2014-0087628, filed on Jul. 11, 2014, entitled “Microphone” which is hereby incorporated by reference in its entirety into this application.

### BACKGROUND

The present disclosure relates to a stamper unit and a method of manufacturing an electrophoretic display using the same.

As an information display device to replace a liquid crystal display device, a display device using techniques such as an electrophoresis method, an electro-chromic method, or a dichroic particles rotary method has been suggested. Display devices using the above techniques have advantages such as a wide angle of view that is close to a typical printing medium such as paper, low power consumption, and memory effects, and thus are regarded as a next-generation display device that may replace the liquid crystal display device, and research into these display devices is being vigorously conducted.

In particular, in the e-paper market, besides ebooks, e-paper exhibiting low power consumption, fast reaction, non-shadowing, a high reflectivity and a high contrast ratio function, which are used in an electric shelf label (ESL), watches, or signboards or the like has been developed.

### RELATED ART DOCUMENT

### Patent Document

(Patent Document 1) Korean Patent Laid-Open Publication No. 2013-0119330

### SUMMARY

An aspect of the present disclosure may provide a stamper unit capable of preventing a residue by filling electronic ink during the manufacturing of an electrophoretic display and a method of manufacturing an electrophoretic display by using the stamper unit.

According to an aspect of the present disclosure, a stamper unit may include: a stamper on which imprint protrusions are formed; and a molding cup that is separably coupled to the stamper and covers the imprint protrusions.

According to another aspect of the present disclosure, a method of manufacturing an electrophoretic display using a stamper unit, may include: forming a resin layer; imprinting the resin layer using a stamper unit including a stamper and a molding cup that is coupled to the stamper and has an ink discharge hole formed therein, to form an ink groove; hardening the resin layer; separating the stamper from the resin layer; filling electronic ink into the ink groove; separating the molding cup from the resin layer; and sealing the ink groove.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view illustrating a stamper unit according to an exemplary embodiment of the present disclosure;

FIG. 2 is a separate cross-sectional view illustrating a stamper unit according to an exemplary embodiment of the present disclosure; and

FIGS. 3 through 10 are conceptual diagrams illustrating a method of manufacturing an electrophoretic display by using a stamper unit, according to an exemplary embodiment of the present disclosure, in a process order.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings

FIG. 1 is a cross-sectional view illustrating a stamper unit 10 according to an exemplary embodiment of the present disclosure.

Referring to FIG. 1, the stamper unit according to an exemplary embodiment of the present disclosure includes a stamper 11 and a molding cup 12.

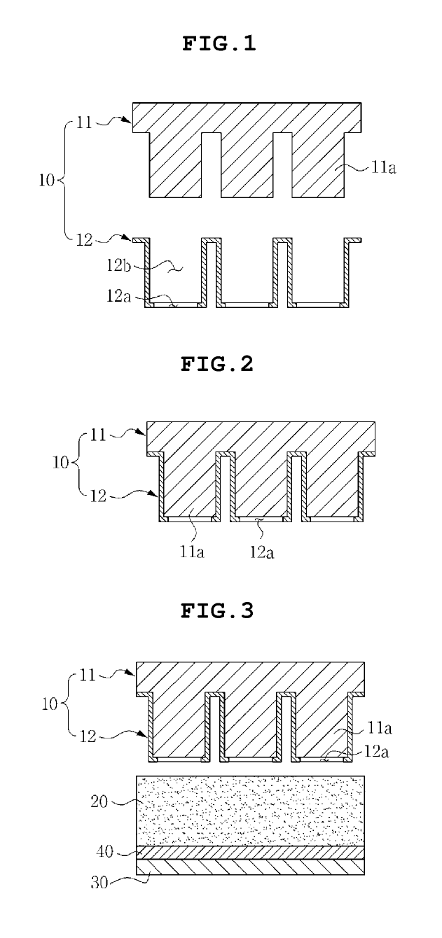

FIG. 2 is a separate cross-sectional view illustrating the stamper unit according to an exemplary embodiment of the present disclosure.

Referring to FIGS. 1 and 2, a plurality of imprint protrusions 11a are formed on a surface of the stamper 11. The imprint protrusions 11a form an ink groove 21 in a resin layer 20 when the resin layer 20 is imprinted using the stamper 11.

Also, the imprint protrusions 11a may have, for example, a rectangular pillar shape or a cylindrical shape, but the shape of the imprint protrusions 11a of the stamper unit 10 according to the exemplary embodiment of the present disclosure is not limited thereto.

The molding cup 12 may be separably coupled to the stamper 11 and formed to cover the surface of the stamper 11 on which the imprint protrusions 11a are formed. Here, the molding cup 12 includes an accommodation portion 12b corresponding to the imprint protrusions 11a. The accommodation portion 12b may be in the form of a groove opened toward the stamper 11. The accommodation portion 12b may be formed in a shape to correspond to the imprint protrusions 11a to form a plurality of grooves corresponding to the number of a plurality of the imprint protrusions 11a.

Also, an ink discharge hole 12a is formed in a lower portion of the accommodation portion 12b in the molding cup 12. The ink discharge hole 12a may be formed to pass through a lower surface of the molding cup 12 so that electronic ink 50 contained in the accommodation portion 12b of the molding cup 12 is discharged to the ink groove 21 formed in the resin layer 20 through the ink discharge hole 12a when the molding cup 12 is separated from the resin layer 20. Here, for example, the ink discharge hole 12a may have a circular shape in a center of the lower surface of the molding cup 12, but the present disclosure is not limited thereto.

In addition, the molding cup 12 may have a predetermined thickness. The molding cup 12 may have, for example, the shape of a curved board or a curved bar, but the shape of the molding cup 12 in the stamper unit 10 according to the exemplary embodiment of the present disclosure is not limited thereto.

The stamper unit 10 including the stamper 11 and the molding cup 12 configured as described above, according to an exemplary embodiment of the present disclosure, is used to imprint the resin layer 20 when manufacturing an electrophorestic display. Here, the stamper 11 may be separated from the resin layer 20, and then electronic ink 50 may be filled into the ink groove 21 formed in the resin layer 20 by using the stamper unit 10, and then the molding cup 12 may be separated from the resin layer 20. The molding cup 12 is formed to cover the surface of the stamper 11 on which the imprint protrusions 11a are formed, and the ink discharge hole 12a is formed in the lower portion of the molding cup 12 so that, when the molding cup 12 is separated, the electronic ink 50 is accommodated in the ink groove 21 through the ink discharge hole 12a. Accordingly, when the electronic ink 50 is filled, generation of ink residues on a surface of the resin layer 20 except the ink groove 21 may be prevented.

FIGS. 3 through 10 are conceptual diagrams illustrating a method of manufacturing an electrophoretic display by using a stamper unit, according to an exemplary embodiment of the present disclosure, in a process order.

Hereinafter, the method of manufacturing an electrophoretic display by using the stamper unit 10 according to an exemplary embodiment of the present disclosure will be described in detail with reference to FIGS. 3 through 10.

The method of manufacturing an electrophoretic display according to an exemplary embodiment of the present disclosure may include: forming of a resin layer, imprinting, hardening the resin layer, separating a stamper, filling ink, separating a molding cup, and sealing. The method of manufacturing an electrophoretic display according to an exemplary embodiment of the present disclosure relates to a method of manufacturing an electrophoretic display by using the stamper unit 10 according to an exemplary embodiment of the present disclosure.

Referring to FIG. 3, in the forming of a resin layer, a resin layer 20 is formed of a resin material. The resin layer 20 may be formed of an ultraviolet (UV) curable resin. However, according to the method of manufacturing an electrophoretic display according to an exemplary embodiment of the present disclosure, the material of the resin layer 20 is not limited to a UV curable resin, and the resin layer 20 may be formed of other materials such as a thermosetting resin, for example.

Also, in the forming of a resin layer, the resin layer 20 is formed on a surface of a transparent substrate 30. The transparent substrate 30 may be formed of, for example, glass or a transparent film, but the present disclosure is not limited thereto.

Meanwhile, the method of manufacturing an electrophoretic display according to an exemplary embodiment of the present disclosure may further include forming of an electrode by patterning an electrode 40 on a surface of the transparent substrate 30.

The electrode 40 may be formed of a transparent electrode and of, for example, indium tin oxide (ITO). However, the material of the electrode 40 according to the method of manufacturing an electrophoretic display according to an exemplary embodiment of the present disclosure is not necessarily limited to ITO, and for example, the electrode 40 may also be formed of a metal mesh, conductive polymer, or the like.

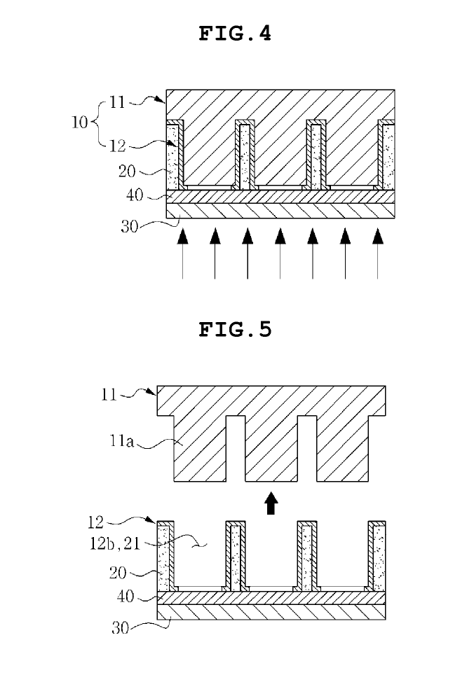

Referring to FIGS. 4 and 5, in the imprinting, a surface of the resin layer 20 is imprinted using the stamper unit 10 to form an ink groove 21.

Here, the stamper unit 10 may include a stamper 11 and a molding cup 12 coupled to the stamper 11.

In detail, a plurality of imprint protrusions 11a are formed on a surface of the stamper 11. The imprint protrusions 11a form the ink groove 21 in the resin layer 20 when the resin layer 20 is imprinted.

Also, the imprint protrusions 11a may have, for example, a rectangular pillar shape or a cylindrical shape, but the shape of the imprint protrusions 11a of the stamper 11 according to the method of manufacturing an electrophoretic display according to an exemplary embodiment of the present disclosure is not necessarily limited thereto.

The molding cup 12 may be separably coupled to the stamper 11 and formed to cover the surface of the stamper 11 on which the imprint protrusions 11a are formed. Here, the molding cup 12 includes an accommodation portion 12b corresponding to the imprint protrusions 11a. The accommodation portion 12b may be in the form of a groove opened toward the stamper 11. The accommodation portion 12b may be formed in a shape to correspond to the imprint protrusions 11a to form a plurality of grooves corresponding to the number of a plurality of the imprint protrusions 11a.

Also, an ink discharge hole 12a is formed in a lower portion of the accommodation portion 12b. The ink discharge hole 12a may be formed to pass through a lower surface of the molding cup 12. Here, the ink discharge hole 12a may have a circular shape in a center of the lower surface of the molding cup 12, but the present disclosure is not limited thereto.

In addition, the molding cup 12 may have a predetermined thickness. The molding cup 12 may have, for example, the shape of a curved board or a curved bar, but the shape of the molding cup 12 according to method of manufacturing an electrophoretic display according to an exemplary embodiment of the present disclosure is not necessarily limited thereto.

In the hardening of the resin layer, an ultraviolet (UV) ray is irradiated to harden the resin layer 20. Here, for example, an ultraviolet curable resin in a liquid state may be changed to a solid polymer if a UV ray is irradiated, but the method of manufacturing an electrophoretic display according to an exemplary embodiment of the present disclosure is not necessarily limited thereto.

Referring to FIG. 5, in the separating of the stamper, the stamper 11 is separated from the resin layer 20. Here, only the stamper 11 is separated from the resin layer 20 while the molding cup 12 is disposed on the resin layer 20 in the stamper unit 10.

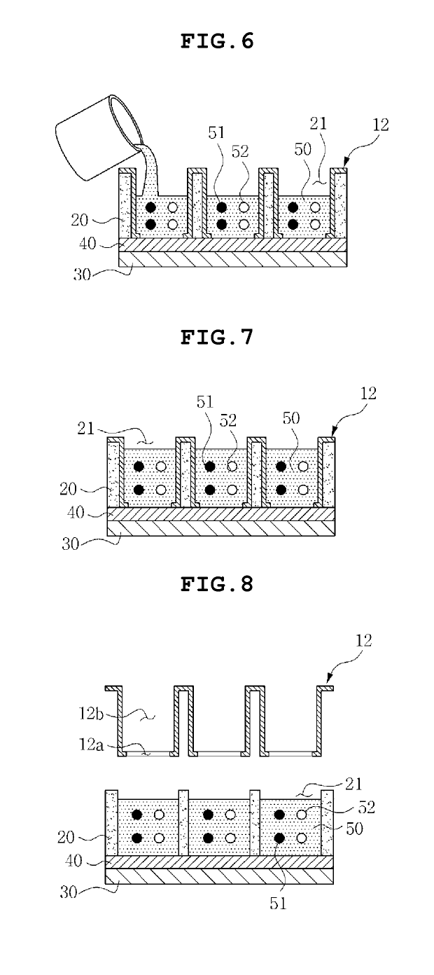

Referring to FIGS. 6 and 7, in the filling of ink, electronic ink 50 is filled into the ink groove 21. The electronic ink 50 may be formed of a dielectric solution containing a plurality of electrophoretic particles 51 and 52. Also, some of the electrophoretic particles 51 and 52 may comprise colored particles 51 that are colored using a dye or a pigment.

Accordingly, the electrophoretic particles 51 and 52 may comprise colored particles 51 and white particles 52. The colored particles 51 may be colored to black or grey, but coloring types of the colored particles 51 according to the method of manufacturing an electrophoretic display according to an exemplary embodiment of the present disclosure are not necessarily limited thereto, and for example, the colored particles 51 may also be colored to other colors than black or grey.

Also, when electricity is applied to the electrophoretic particles 51 and 52 through the electrode 40, information may be displayed as arrangement of the colored particles 51 and the white particles 52 of the electrophoretic particles 51 and 52 is adjusted. Here, the electrophoretic particles 51 and 52 may respectively have, for example, positive charges and negative charges. For example, the colored particles 51 and the white particles 52 may have different charges, but the present disclosure is not necessarily limited thereto.

Referring to FIG. 8, in the separating of the molding cup, the molding cup 12 is separated from the resin layer 20. The ink discharge hole 12a is formed in the lower portion of the molding cup 12 so that, when the molding cup 12 is separated from the resin layer 20, the electronic ink 50 is discharged to the ink discharge hole 12a so as to be contained in the ink groove 21.

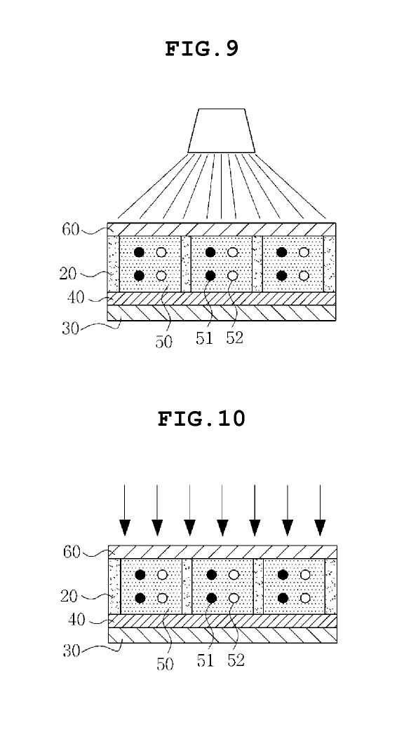

Referring to FIGS. 9 and 10, in the sealing, the ink groove 21 is sealed. In the sealing, a sealing agent is ejected onto the surface of the resin layer 20 on which the ink groove 21 is formed to thereby form a sealing layer 60.

Here, in the hardening of the ink, a UV ray is irradiated to the sealing agent ejected onto the surface of the resin layer 20 to harden the sealing agent, thereby forming the sealing layer 60.

According to the method of manufacturing an electrophoretic display of an exemplary embodiment of the present disclosure, configured as described above, the resin layer 20 is imprinted using the stamper unit 10 including the stamper 11 and the molding cup 12. Here, after separating the stamper 11 from the resin layer 20, the electronic ink 50 may be filled into the ink groove 21 which is formed in the resin layer 20 by using the stamper unit 10, and the molding cup 12 may be separated from the resin layer 20. Here, the molding cup 12 may be formed to cover the surface of the stamper 11 on which the imprint protrusions 11a are formed, and as the ink discharge hole 12a is formed in the lower portion of the molding cup 12, the electronic ink 50 is accommodated in the ink groove 21 through the ink discharge hole 12a when the molding cup 12 is separated. Accordingly, when the electronic ink 50 is filled, generation of a residue on the surface of the resin layer 20 except the ink groove 21 may be prevented.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. A stamper unit comprising:
a stamper on which imprint protrusions are formed; and
a molding cup that is separably coupled to the stamper and covers the imprint protrusions.

2. The stamper unit of claim 1, wherein an ink discharge hole is formed in a lower portion of the molding cup.

3. The stamper unit of claim 2, wherein an accommodation portion having a shape corresponding to the imprint protrusions is formed in the molding cup.

4. The stamper unit of claim 3, wherein a plurality of the imprint protrusions are formed on a surface of the stamper.

5. The stamper unit of claim 1, wherein the imprint protrusions are formed on a surface of the stamper, and
the molding cup is formed to cover the surface of the stamper.

6. The stamper unit of claim 5, wherein the molding cup has a predetermined thickness.

7. A method of manufacturing an electrophoretic display, the method comprising:
forming a resin layer;
imprinting the resin layer using a stamper unit including a stamper and a molding cup that is coupled to the stamper and has an ink discharge hole formed therein, to form an ink groove;
separating the stamper from the resin layer;
filling electronic ink into the ink groove;
separating the molding cup from the resin layer; and
sealing the ink groove.

8. The method of claim 7, wherein imprint protrusions that form the ink groove are formed on the stamper, and
the molding cup is separably coupled to the stamper to cover the imprint protrusions.

9. The method of claim 8, wherein the ink discharge hole is formed in a lower portion of the molding cup so that the electronic ink is discharged to the ink discharge hole when the molding cup is separated from the resin layer.

10. The method of claim 9, wherein an accommodation portion having a shape corresponding to the imprint protrusions is formed in the molding cup.

11. The method of claim 10, wherein a plurality of the imprint protrusions are formed on a surface of the stamper.

12. The method of claim 11, wherein the imprint protrusions are formed on the surface of the stamper, and
the molding cup is formed to cover the surface of the stamper.

13. The method of claim 12, wherein the molding cup has a predetermined thickness.

14. The method of claim 7, further comprising, after the imprinting and before the separating of the stamper, hardening the resin layer.

15. The method of claim 14, wherein in the hardening of the resin layer, an ultraviolet (UV) ray is irradiated to harden the resin layer.

16. The method of claim 15, wherein in the forming of a resin layer, the resin layer is formed of a UV curable resin.

17. The method of claim 7, wherein in the sealing, a sealing layer is formed by ejecting a sealing agent onto a surface of the resin layer in which the ink groove is formed.

18. The method of claim 17, wherein in the sealing, an UV ray is irradiated onto the ejected sealing agent to harden the sealing agent so as to form the sealing layer.

19. The method of claim 7, wherein in the forming of the resin layer, the resin layer is formed on a surface of a transparent substrate.

20. The method of claim 19, further comprising, before the forming of the resin layer, forming an electrode by patterning an electrode on the surface of the transparent substrate.
